(19) United States
(12) Patent Application Publication
(10) Pub. No.: US 2025/0164309 A1
(43) Pub. Date: May 22, 2025

(54) REMOTE INTELLIGENT CONTROL MEASUREMENT AND DETECTION DEVICE AND METHOD FOR NOISE MEASUREMENT AND ANALYSIS INSTRUMENT

(71) Applicants: Zhejiang Province Institute of Metrology, Hangzhou Zhejiang (CN); Hangzhou Aihua Instruments Co., Ltd, Hangzhou Zhejiang (CN)

(72) Inventors: Zhikai ZHANG, Hangzhou Zhejiang (CN); Shan HE, Hangzhou Zhejiang (CN); Jicun JIN, Hangzhou Zhejiang (CN); Mingjun CHENG, Hangzhou Zhejiang (CN); Shuaijun SANG, Hangzhou Zhejiang (CN); Wenle JIANG, Hangzhou Zhejiang (CN); Delin WU, Hangzhou Zhejiang (CN); Jianmin QIU, Hangzhou Zhejiang (CN); Shenping GAO, Hangzhou Zhejiang (CN); Yali PENG, Hangzhou Zhejiang (CN); Xiaobo WANG, Hangzhou Zhejiang (CN)

(21) Appl. No.: 18/636,774

(22) Filed: Apr. 16, 2024

(30) Foreign Application Priority Data
Nov. 20, 2023 (CN) 2023115423192

(51) Int. Cl. G01H 17/00; G01D 21/02; G16Y 20/10; G16Y 40/10

(52) U.S. Cl. CPC G01H 17/00; G01D 21/02; G16Y 20/10; G16Y 40/10

(57) ABSTRACT

A remote intelligent control measurement and detection device and method for a noise measurement and analysis instrument, which relates to the technical fields of noise measurement and Internet of Things (IoT). The remote intelligent control measurement and detection for the noise measurement and analysis instrument includes a remote intelligence control and certificate management system, a remote measurement and detection platform, an automatic detection device, a video monitoring system and a supporting facility. The device has the advantages that by implementing the technology of a combination of “measurement and detection platform+Internet of Things remote intelligent control”, an intelligent IoT remote intelligent control system with an IoT video and data security as a core is formed, and remote control and automatic detection of the digital noise measurement and analysis instrument, and analysis, calculation, storage, transmission and original recording of detection data, and automatic generation of a certificate report are achieved.

### TECHNICAL FIELD

The present disclosure relates to the technical fields of noise measurement and Internet of Things (IoT), in particular to a remote intelligent control measurement and detection device and method for a noise measurement and analysis instrument.

### BACKGROUND

With the new characteristics of Internet of Everything and Intelligence of Everything presented by a new round of science and technology, relevant documents also propose that the transformation of the traditional electronic information manufacturing industry to a digital standard is accelerated. In the field of noise monitoring, a digital noise measurement and analysis instrument has become an important carrier for a new generation of noise monitoring, refers to an intelligent multi-element integrated noise test instrument with the functions of noise data collection, information processing, information exchange, and information storage as an important means of interacting with the external environment and a main source of perceived information, and is a noise test product that integrates a microphone, a communication module, a microprocessor, a driver program, a software algorithm, and the like. In order to ensure the accuracy and reliability of monitoring data, the digital noise measurement and analysis instrument is also listed in the statistical scope of the core industry of the digital economy, and it is determined to organize regular statistical monitoring of the digital noise measurement and analysis instrument industry in the whole province.

In the prior art, there are many measurement and detection items of the noise measurement and analysis instrument, and when the amount sent for detection increases, additional equipment and personnel are needed for detection, thus reducing the detection efficiency and increasing the additional cost. Often, for users who can't wait, detected instruments will be sent to other measurement technical institutions for measurement and detection, resulting in business loss for local measurement technical institutions. In order to help users send the detected instruments, enterprises need to arrange special personnel to handle this business, and go back and forth to measurement and detection institutions for many times, resulting in high costs. In addition, when the enterprises test the technical indicators of a newly developed product, due to the lack of laboratory qualification and technical strength, only simple technical indicators and general test reports can be provided, and thus the product still needs to be sent to other authorized measurement technical institutions for detection, resulting in the increase of product development period and cost.

In order to make up for the deficiencies in the existing measurement and detection work, while strengthening the research of an intelligent measurement and calibration technology, promoting the application of new technologies such as Internet of Things, blockchains, and artificial intelligence in measuring instruments and equipment, innovating an intelligent measurement supervision mode, and actively building a new intelligent measurement system and other related requirements through instrument intelligence and data systematization, the present disclosure provides a remote intelligent control measurement and detection device and method for a noise measurement and analysis instrument, by implementing the technology of a combination of “measurement and detection platform+Internet of Things remote intelligent control”, an intelligent IoT remote intelligent control system with an IoT video and data security as a core is formed, and remote control and automatic detection of the digital noise measurement and analysis instrument, and analysis, calculation, storage, transmission and original recording of detection data, and automatic generation of a certificate report are achieved, effectively improving the measurement and detection efficiency and quality, while shortening the measurement and detection period and saving manpower.

### SUMMARY

An object of the present disclosure is to overcome the defects in the prior art, and provides a remote intelligent control measurement and detection device and method for a noise measurement and analysis instrument. An intelligent IoT remote intelligent control system with an IoT video and data security as a core is constructed, and remote control and automatic detection of a digital noise measurement and analysis instrument, and analysis, calculation, storage, transmission and original recording of detection data, and automatic generation of a certificate report are achieved, effectively improving the measurement and detection efficiency and quality, while shortening the measurement and detection period and saving manpower.

To achieve the above object, the present disclosure provides a remote intelligent control measurement and detection device for a noise measurement and analysis instrument, including a remote intelligence control and certificate management system, a remote measurement and detection platform, an automatic detection device, a video monitoring system and a supporting facility, wherein the remote intelligence control and certificate management system is in two-way communication with the remote measurement and detection platform, the remote measurement and detection platform is in two-way communication with the automatic detection device, the video monitoring system and the supporting facility are in two-way communication with the remote intelligence control and certificate management system, and the automatic detection device includes an anechoic chamber, a low-frequency coupler, a multi-function acoustic calibrator, a signal generator, a measurement amplifier, a high-fidelity test sound source, a power amplifier and a multi-channel signal analyzer.

The remote intelligent control measurement and detection device for the noise measurement and analysis instrument includes a running status indicator light for accurately identifying a detection status.

The video monitoring system includes a video camera, a human face recognition device, and a fingerprint recognition system.

The supporting facility includes a barometer, a thermometer and a hygrometer which enable remote communication.

The remote intelligence control and certificate management system is connected with the remote measurement and detection platform through an Internet of Things remote transmission protocol, and the test instructions and the test results can be transmitted in real time through a data encryption technique, enabling remote environmental monitoring and access control data management, field test data collection and transmission, original record compilation, certificate template matching and automatic certificate generation.

Deep mining of measurement data can be carried out based on digital test data management, the deep mining of the measurement data including data mining of detection data, building a sound field database, and mining information of a standard measuring instrument, thus implementing an expiration reminder of a standard device, the information of the standard measuring instrument including a model, a number, a measurement range, an accuracy level, and a tracing period.

The remote measurement and detection platform is connected with the automatic detection device and the detected instrument through a serial port or a network port, enabling control of the automatic detection device and acquisition of detection data, and a system specific network is established by using a 4G/5G-VPN manner. Data security protection is performed by RAS public key encryption during data transmission.

A plurality of remote measurement and detection platforms adopt a manner of being separately deployed, avoiding the impact of platform abnormality on a testing business of other platforms, and increasing security; and a network interruption and continuous transmission mechanism is provided to ensure that data is not affected by emergency situations such as network port failure, server interruption, and main server downtime, improving reliability.

Provided is a detection method of the remote intelligent control measurement and detection device for the noise measurement and analysis instrument, and a specific detection process includes the steps of:
S1, connecting the automatic detection device with a detected instrument by detection assisting personnel, and waiting for instructions from the remote intelligence control and certificate management system;
S2, issuing instructions to start testing by the remote intelligence control and certificate management system, and acquiring characteristic data of a to-be-detected instrument by the automatic detection device through a serial port or a network port, wherein the characteristic data includes a model, a number, a sensitivity level, a frequency range, a measuring range, and a reference sound pressure level;
S3, remotely controlling the signal generator to send out signals of a specific frequency and amplitude according to the requirements of measurement and detection to detect the electrical performance and the acoustic performance of the detected instrument;
S4, acquiring measurement data of the to-be-detected instrument by a main control unit through a serial port or a network port;
S5, analyzing the measurement data, and calculating a test result to end a test of one measurement index, while automatically uploading the measurement data to a database of the remote intelligence control and certificate management system;
S6, repeating the steps S3 to S5 to complete detection of all measurement indexes; and
S7, prompting the detection to be completed and automatically generating original records and certificates of measurement and detection by the remote intelligence control and certificate management system.

In the process of remote measurement and detection of the noise measurement and analysis instrument by using a remote measurement and detection device, the acoustic performance has two measurement and detection methods, and specific measurement and detection processes respectively include the following steps:
S0, issuing instructions by the remote intelligence control and certificate management system, using the automatic detection device to achieve detection of conventional electrical performance measurement parameters, and detecting the acoustic performance (e.g., frequency weighting of acoustic signals) by a free field comparison method or a multi-function acoustic calibrator method using a standard microphone;

### S1, the Free Field Comparison Method

S1-1, detecting the acoustic performance by the free field comparison method using the standard microphone first needs to perform calibration on a sound pressure level of a free field in the anechoic chamber, and mainly includes the following steps:
S1-1-1, performing measurement of sound field calibration by the remote measurement and detection platform, the low-frequency coupler, the anechoic chamber, the high-fidelity test sound source, the standard microphone and the like;
S1-1-2, building a sound field automatic calibration system in the anechoic chamber to calibrate a position of the standard microphone;
S1-1-3, the sound field automatic calibration system including an electric telescopic rod and a laser positioning device, after the standard microphone is fixed to one end of the electric telescopic rod, performing three-way calibration on a position of the standard microphone and a position of a sound source by the laser positioning device, and finally guaranteeing that a center position of the standard microphone is coaxial with a center position of the sound source by adjusting the electric telescopic rod;
S1-1-4, constructing a sound field playback system in the anechoic chamber to calibrate the reference sound pressure level; and
S1-1-5, the sound field playback system in the anechoic chamber including the standard microphone, the high-fidelity test sound source, the signal generator and the remote measurement and detection platform, controlling, by the remote measurement and detection platform, the signal generator to send out an acoustic signal of a reference frequency through a high-fidelity sound source, reading a sound pressure level of the standard microphone through a serial port, adjusting a voltage value of the signal generator until a sound pressure level received by the standard microphone is the reference sound pressure level, and recording a current voltage value of the signal generator; and keeping the current voltage value unchanged, and playing signals by a digital detection system by means of an octave or fractional octave point frequency while recording a sound pressure level at each frequency point received by the standard microphone;
S1-2, after a sound pressure level of a free sound field is calibrated, replacing the standard microphone with the detected instrument, and ensuring that a position of a sound center of the detected instrument is the same as that of the standard microphone; and then reading the voltage value of the signal generator recorded in S1-1-5, and controlling the sound field playback system to send out an acoustic signal by the remote measurement and detection platform while reading and recording the sound pressure level at each frequency point of the detected instrument through a serial port; and
S1-3, automatically calculating a difference between the sound pressure level of the standard microphone and the sound pressure level of the detected instrument by the remote measurement and detection platform, and adding a correction value to finally obtain frequency weighting of an acoustic signal at each frequency point;
S2, the multi-function acoustic calibrator method; wherein the multi-function acoustic calibrator is used to simplify measurement of the acoustic performance, eliminate the use of the anechoic chamber, and reduce intervention of metering personnel on a measurement and detection process, improving the detection efficiency, and specific measurement steps include:

S2-1, measuring a microphone type correction value of the detected instrument by the multi-function acoustic calibrator;
S2-1-1, placing the detected instrument in the anechoic chamber, giving each frequency of the correction value according to instrument instructions, and measuring an output sound pressure level at each frequency point of the detected instrument by the remote measurement and detection platform;
S2-1-2, keeping a sound pressure level of each frequency in the anechoic chamber unchanged, replacing the detected instrument with a reference laboratory standard (LS2P) microphone, and keeping a position of a sound center of the detected instrument to be the same as that of the reference laboratory standard microphone; and reading a sound pressure level measured by the reference laboratory standard microphone by the remote measurement and detection platform on the same frequency point as that in S2-1-1;
S2-1-3, using the multi-function acoustic calibrator in the detected instrument in S2-1-1, controlling the multi-function acoustic calibrator to send out an acoustic signal of a corresponding frequency by the remote measurement and detection platform, and reading the output sound pressure level at each frequency point of the detected instrument;
S2-1-4, using the multi-function acoustic calibrator in the detected instrument in S2-1-2, controlling the multi-function acoustic calibrator to send out an acoustic signal of a corresponding frequency by the remote measurement and detection platform, and reading the output sound pressure level at each frequency point of the detected instrument;
S2-1-5, after the measurement is completed, calculating a correction value at each frequency point by the remote measurement and detection platform based on the following formula 1, and repeating S2-1-1 to S2-1-4 to calculate an average of the correction values by multiple measurements:

$${C}_{FF , SLM} = ( {L}_{ind 1} - {L}_{ind 3} ) - ( {L}_{ind 2} + {L}_{ind 4} ) - ( {L}_{p , F 1} - {L}_{p , F 2} ) + ( {L}_{p , P 1} - {L}_{p , P 2} ) + {C}_{F F , RM} ; \qquad Formula 1$$

the C_{FF,SLM} is a correction value of a free field which is effective for the used noise measurement and analysis instrument and the used multi-function acoustic calibrator;
the C_{FF,RM} is a correction value of a free field of a reference microphone;
the L_{ind1}, the L_{ind2}, the L_{ind3}, and the L_{ind4} are indicating levels during measurements 1, 2, 3, and 4, respectively;
the L_{p,F1} and the L_{p,F2} are sound pressure levels of a free field during measurements 1 and 2, respectively;
the L_{p,p1} and the L_{p,p2} are measured values of sound pressure levels applied with the multi-function acoustic calibrator during measurements 3 and 4, respectively;
S2-1-6, finally obtaining a correction value of the multi-function acoustic calibrator for the detected instrument, and saving the correction value in a sound field database; and
S2-2, using the multi-function acoustic calibrator to measure each frequency point of the detected instrument, and retrieving the correction value of the detected instrument in the database to finally obtain frequency weighting of the acoustic signal at each frequency point.

The beneficial effects of the present disclosure are as follows:

1. higher terminal controllability: a plurality of the remote measurement and detection platforms can be provided at different locations. Due to the multi-point distribution of the remote measurement and detection platforms and various specifications and models of the detected instrument, when a certain platform terminal is abnormal during testing, and needs to input information or manual intervention, it is necessary for measurement and detection personnel to remotely monitor the situation of a terminal desktop in real time and determine whether the operation of system detection personnel is reasonable. By integrating platform terminals in the manner of integration of a data interface and an operating desktop, desktop monitoring can be performed at any time during the test process, and a remote desktop can be operated, and the complete controllability of a test terminal can be achieved.

2. Higher security: the remote measurement and detection platforms are deployed separately, integrating the abnormality of a system or the abnormality of a certain subsystem without affecting the test business of other subsystems, thus ensuring the safe operation of the whole system to the greatest extent.

3. Higher reliability: the network interruption and continuous transmission mechanism is provided. If there are emergency situations such as network port failure, interruption of a certain server, and main server downtime during the process, the business development of the system will not be affected, the business development of each subsystem can still be monitored and viewed with the cooperation of a monitoring camera, and only data measured by the terminal needs to be reviewed and uploaded complementarily after the failure is resolved to ensure the reliable operation of the whole system.

4. Ease of maintenance: when a certain business needs the cooperation of a business system to increase, decrease or change its demand due to standard modifications and business process changes, a subsystem designer can cooperate with the changes more directly without the cooperation of a remote intelligent control system.

5. High cohesion and low coupling: an architectural approach of multiple service terminals in one data center is adopted. A business terminal of each subsystem is responsible by different business manufacturers, measurement software has only the function of reporting result data, it is only necessary to ensure the accuracy of the reported data, and a control process is not involved. Therefore, when a problem occurs at a control side, only a remote intelligent control platform manufacturer needs to deal with the problem independently, without the need for a developer of each subsystem to participate in troubleshooting simultaneously.

6. Universality: high compatibility with control software and computer systems of different manufacturers, solving the problem of inability to remotely control verification platforms of different business systems due to technical differences.

### BRIEF DESCRIPTION OF FIGURES

FIG. 1 is a structural schematic diagram of a detection device according to the present disclosure;

FIG. 2 is a schematic diagram of electrical performance measurement and detection according to the present disclosure;

FIG. 3 is a schematic diagram of low-frequency acoustic signal measurement and detection according to the present disclosure;

FIG. 4 is a schematic diagram of high-frequency acoustic signal measurement and detection according to the present disclosure;

FIG. 5 is a schematic diagram of acoustic measurement performance detection using a multi-function acoustic calibrator method according to the present disclosure;

FIG. 6 is a schematic diagram of an interaction between a remote intelligent control and certificate management system and a remote measurement and detection platform according to the present disclosure; and

FIG. 7 is a schematic diagram of data transmission between a remote intelligent control platform and a plurality of remote measurement and detection platforms, video monitoring systems and supporting facilities according to the present disclosure.

### DETAILED DESCRIPTION

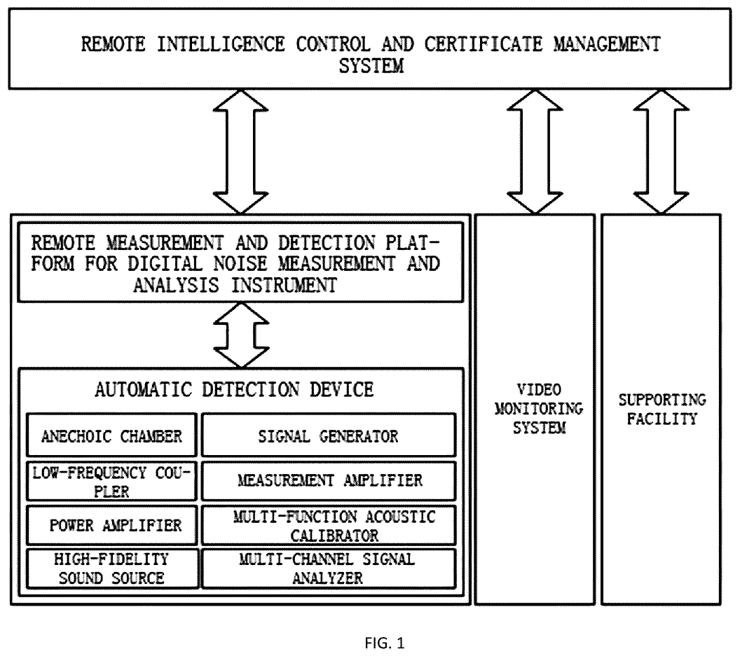

The present disclosure provides a remote intelligent control measurement and detection device for a noise measurement and analysis instrument, including a remote intelligence control and certificate management system, a remote measurement and detection platform, an automatic detection device, a video monitoring system and a supporting facility, wherein the remote intelligence control and certificate management system is in two-way communication with the remote measurement and detection platform, the remote measurement and detection platform is in two-way communication with the automatic detection device, the video monitoring system and the supporting facility are in two-way communication with the remote intelligence control and certificate management system, and the automatic detection device includes an anechoic chamber, a low-frequency coupler, a multi-function acoustic calibrator, a signal generator, a measurement amplifier, a high-fidelity test sound source, a power amplifier and a multi-channel signal analyzer in hardware facility configuration (see FIG. 1). Supporting equipment or facilities (such as a barometer, a thermometer, a hygrometer, etc. which can achieve remote communication) required for the remote intelligent control measurement and detection device are also included.

The remote intelligent control measurement and detection device for the noise measurement and analysis instrument includes a running status indicator light for accurately identifying a detection status.

The video monitoring system includes a video camera, a human face recognition device, and a fingerprint recognition system.

The video monitoring system includes a plurality of video cameras to achieve omnidirectional monitoring of the entire instrument remote automatic detection process. The system monitors and records the detection process and the running status of measuring instruments and equipment in real time while uploading the detection process and the running status to a server for subsequent verification work. Basic information such as a model, a factory number and a manufacturer of the detected instrument and a change in an indicated value during detection are monitored to achieve comparison with data read by a serial port to ensure the accuracy of the data read by the serial port. Access control monitoring such as human face recognition and fingerprint recognition is set at an entrance and exit of a laboratory, only authorized persons are allowed to install a detected instrument, and unauthorized persons cannot enter, otherwise an alarm device will be triggered.

In use, the detection assisting personnel connect the automatic detection device with the detected instrument, and then the acoustic performance of the noise measurement and analysis instrument can be measured and tested through the remote measurement and detection platform and the remote intelligent control and certificate management system.

The independent modules of the measurement and detection device are connected through standardized interfaces, and can be controlled by a digital detection system through a control bus to carry out signal output, processing, data reading and other operations. The automatic detection device is composed of a plurality of independent functional modules, such as the high-fidelity test sound source, the signal generator, the power amplifier, the low-frequency coupler, the measurement amplifier, the multi-channel signal analyzer, the multi-function acoustic calibrator, etc., the modules are controlled by the digital detection system through the control bus to carry out signal output, and the signal frequency, amplitude and type are controllable. The detection assisting personnel connects the detected instrument with the automatic detection device through a wired or wireless mode, data communication is achieved through a communication protocol of the detected instrument, and a corresponding interface code is written to obtain test data, thereby conducting measurement performance detection of the detected instrument.

The functions of the detected instrument typically include noise integration, statistics and filter functions, etc., and its measurement performance includes electrical performance (self-generated electrical noise, level linearity, electrical signal frequency weighting, time weighting, tone burst response, repeated tone burst response, a peak C sound level, statistical calculation, relative attenuation, etc.) and acoustic performance (self-generated noise, an indicating sound level and acoustic signal frequency weighting, etc.).

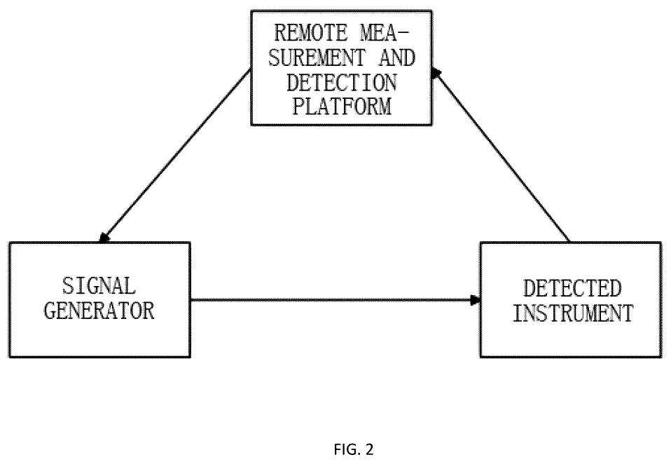

A detection method of the remote intelligent control measurement and detection device for the noise measurement and analysis instrument includes the steps of:
S1, connecting the automatic detection device with a detected instrument by detection assisting personnel, and waiting for instructions from the remote intelligence control and certificate management system;
S2, issuing instructions to start testing by the remote intelligence control and certificate management system, and acquiring characteristic data of a to-be-detected instrument by the automatic detection device through a serial port or a network port, wherein the characteristic data includes a model, a number, a sensitivity level, a frequency range, a measuring range, and a reference sound pressure level;
S3, (see FIG. 2) remotely controlling the signal generator to send out signals of a specific frequency and amplitude according to the requirements of measurement and detection to detect the electrical performance and the acoustic performance of the detected instrument;
S4, acquiring measurement data of the to-be-detected instrument by a main control unit through a serial port or a network port;
S5, analyzing the measurement data, and calculating a test result to end a test of one measurement index, while automatically uploading the measurement data to a database of the remote intelligence control and certificate management system;
S6, repeating the steps S3 to S5 to complete detection of all measurement indexes; and
S7, prompting the detection to be completed and automatically generating original records and certificates of measurement and detection by the remote intelligence control and certificate management system.

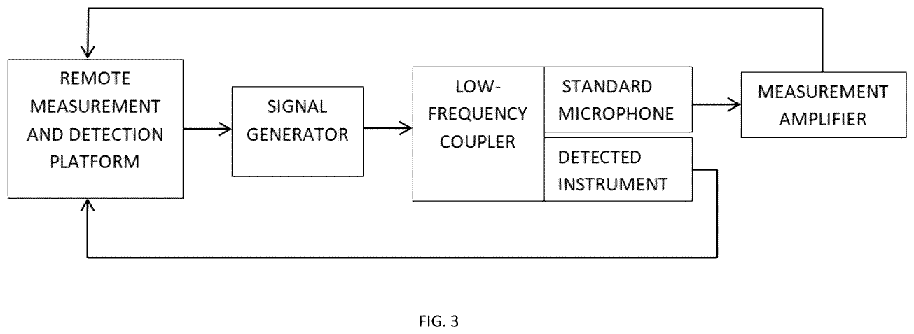

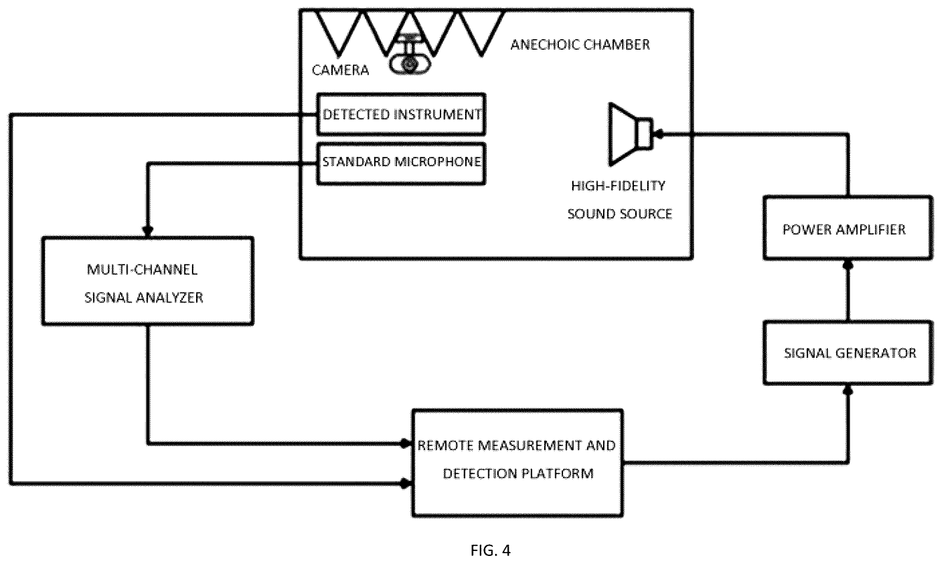

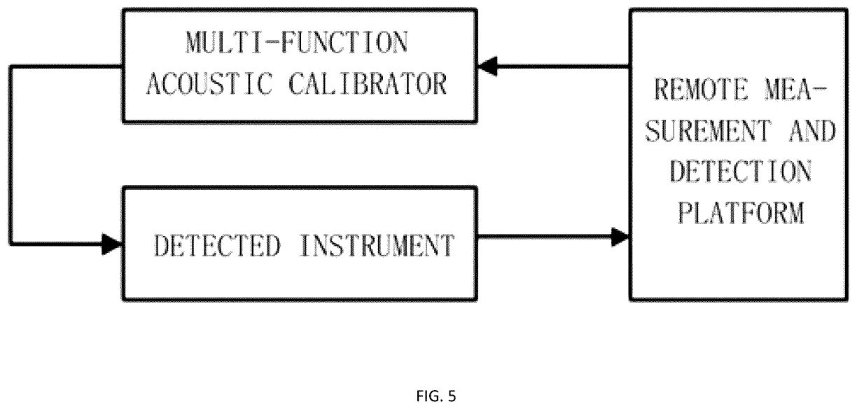

In the process of remote measurement and detection of a digital noise measurement and analysis instrument by using a remote measurement and detection device, the acoustic performance has two measurement and detection methods, and specific measurement and detection processes respectively include the following steps:
S0, issuing instructions by the remote intelligence control and certificate management system, using the automatic detection device to achieve detection of conventional electrical performance measurement parameters, and detecting the acoustic performance (e.g., frequency weighting of acoustic signals) by a free field comparison method or a multi-function acoustic calibrator method using a standard microphone; S1, the free field comparison method
S1-1, detecting the acoustic performance by the free field comparison method using the standard microphone first needs to perform calibration on a sound pressure level of a free field in the anechoic chamber, and mainly includes the following steps:
S1-1-1, (see FIG. 3), performing measurement of sound field calibration by the remote measurement and detection platform, the low-frequency coupler, the anechoic chamber, the high-fidelity test sound source, the standard microphone and the like;
S1-1-2, building a sound field automatic calibration system in the anechoic chamber to calibrate a position of the standard microphone;
S1-1-3, the sound field automatic calibration system including an electric telescopic rod and a laser positioning device, after the standard microphone is fixed to one end of the electric telescopic rod, performing three-way calibration on a position of the standard microphone and a position of a sound source by the laser positioning device, and finally guaranteeing that a center position of the standard microphone is coaxial with a center position of the sound source by adjusting the electric telescopic rod;
S1-1-4, constructing a sound field playback system in the anechoic chamber to calibrate the reference sound pressure level; and
S1-1-5, (see FIG. 4), the sound field playback system in the anechoic chamber including the standard microphone, the high-fidelity test sound source, the signal generator and the remote measurement and detection platform, controlling, by the remote measurement and detection platform, the signal generator to send out an acoustic signal of a reference frequency through a high-fidelity sound source, reading a sound pressure level of the standard microphone through a serial port, adjusting a voltage value of the signal generator until a sound pressure level received by the standard microphone is the reference sound pressure level, and recording a current voltage value of the signal generator; and keeping the current voltage value unchanged, and playing signals by a digital detection system by means of an octave or fractional octave point frequency while recording a sound pressure level at each frequency point received by the standard microphone;
S1-2, after a sound pressure level of a free sound field is calibrated, replacing the standard microphone with the detected instrument, and ensuring that a position of a sound center of the detected instrument is the same as that of the standard microphone; and then reading the voltage value of the signal generator recorded in S1-1-5, and controlling the sound field playback system to send out an acoustic signal by the remote measurement and detection platform while reading and recording the sound pressure level at each frequency point of the detected instrument through a serial port; and
S1-3, automatically calculating a difference between the sound pressure level of the standard microphone and the sound pressure level of the detected instrument by the remote measurement and detection platform, and adding a correction value to finally obtain frequency weighting of an acoustic signal at each frequency point;
S2, the multi-function acoustic calibrator method; wherein the multi-function acoustic calibrator is used to simplify measurement of the acoustic performance, eliminate the use of the anechoic chamber, and reduce intervention of metering personnel on a measurement and detection process, improving the detection efficiency, and specific measurement steps include:
S2-1, measuring a microphone type correction value of the detected instrument by the multi-function acoustic calibrator;
S2-1-1, placing the detected instrument in the anechoic chamber, giving each frequency of the correction value according to instrument instructions, and measuring an output sound pressure level at each frequency point of the detected instrument by the remote measurement and detection platform;
S2-1-2, keeping a sound pressure level of each frequency in the anechoic chamber unchanged, replacing the detected instrument with a reference laboratory standard (LS2P) microphone, and keeping a position of a sound center of the detected instrument to be the same as that of the reference laboratory standard microphone; and reading a sound pressure level measured by the reference laboratory standard microphone by the remote measurement and detection platform on the same frequency point as that in S2-1-1;
S2-1-3, (see FIG. 5), using the multi-function acoustic calibrator in the detected instrument in S2-1-1, controlling the multi-function acoustic calibrator to send out an acoustic signal of a corresponding frequency by the remote measurement and detection platform, and reading the output sound pressure level at each frequency point of the detected instrument;
S2-1-4, using the multi-function acoustic calibrator in the detected instrument in S2-1-2, controlling the multi-function acoustic calibrator to send out an acoustic signal of a corresponding frequency by the remote measurement and detection platform, and reading the output sound pressure level at each frequency point of the detected instrument;
S2-1-5, after the measurement is completed, calculating a correction value at each frequency point by the remote measurement and detection platform based on the following formula 1, and repeating S2-1-1 to S2-1-4 to calculate an average of the correction values by multiple measurements:

$${C}_{FF , SLM} = ( {L}_{ind 1} - {L}_{ind 3} ) - ( {L}_{ind 2} + {L}_{ind 4} ) - ( {L}_{p , F 1} - {L}_{p , F 2} ) + ( {L}_{p , P 1} - {L}_{p , P 2} ) + {C}_{F F , RM} ; \qquad Formula 1$$

the C_{FF,SLM} is a correction value of a free field which is effective for the used noise measurement and analysis instrument and the used multi-function acoustic calibrator;
the C_{FF,RM} is a correction value of a free field of a reference microphone;
the L_{ind1}, the L_{ind2}, the L_{ind3}, and the L_{ind4} are indicating levels during measurements 1, 2, 3, and 4, respectively;
the L_{p,F1} and the L_{p,F2} are sound pressure levels of a free field during measurements 1 and 2, respectively;
the L_{p,P1} and the L_{p,P2} are measured values of sound pressure levels applied with the multi-function acoustic calibrator during measurements 3 and 4, respectively;
S2-1-6, finally obtaining a correction value of the multi-function acoustic calibrator for the detected instrument, and saving the correction value in a sound field database; and
S2-2, using the multi-function acoustic calibrator to measure each frequency point of the detected instrument, and retrieving the correction value of the detected instrument in the database to finally obtain frequency weighting of the acoustic signal at each frequency point.

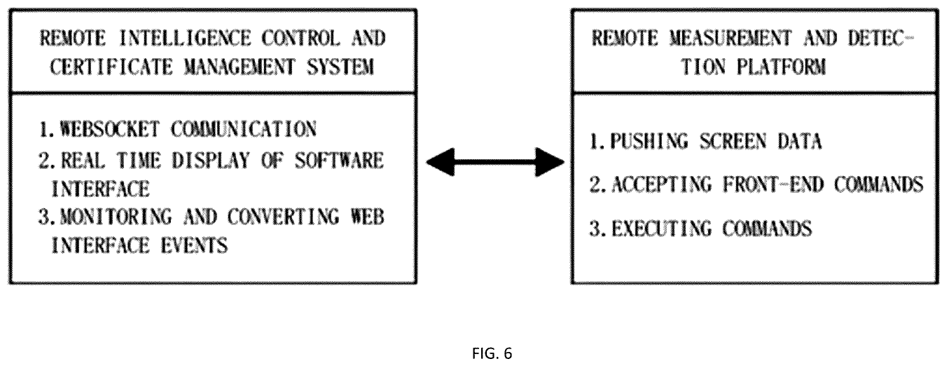

Referring to FIG. 6, the remote intelligence control and certificate management system and the remote measurement and detection platform achieve remote control through an Internet of Things technology transmission protocol.

In terms of data transmission, data communication between the remote measurement and detection platform and the automatic detection device is achieved through a communication protocol of the detected instrument, a corresponding interface code is written to obtain test data, so as to realize detection of the measurement performance of the detected instrument.

According to the requirements of measurement and detection parameters, the remote control content and read data information to be read required for each detection are listed and then summarized, a communication protocol of control instructions and test data information return instructions is designed, these two types of instructions need to contain various control factors and data factors that may be used, so that the automatic detection device can perform efficient measurement and detection analysis and obtain test results. Transmission instructions also need to include verification processes for various types of information, such as detection assisting personnel information verification (fingerprint recognition or human face recognition) and detection device recognition.

In order to ensure the security of data transmission, a system adopts a 4G/5G-VPN manner to establish a system special network. In order to further improve the security of data, encryption will also be performed during data transmission, and the encryption adopts RSA public key encryption.

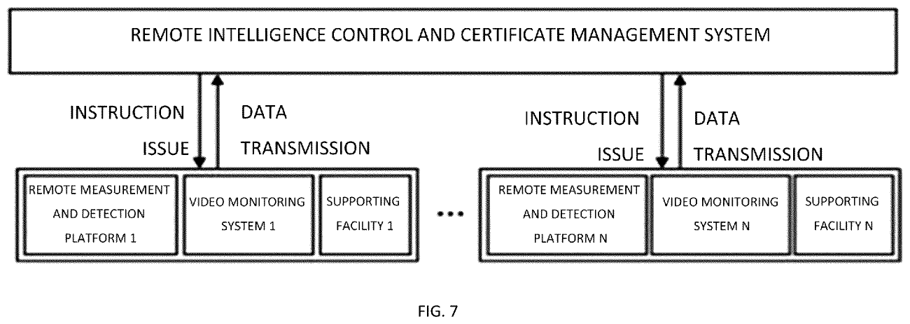

Referring to FIG. 7, the remote intelligence control and certificate management system controls a measurement and detection device of the noise measurement and analysis instrument to measure and detect the acoustic performance of the detected instrument through the remote measurement and detection platform, and is responsible for the storage and analysis of all data of the entire system, including measurement and detection data, environmental monitoring data, information of the detected instrument and a standard device, access control information, monitoring information, and the like, all data and monitoring processes for each detection can be traced on system software, providing a docking interface with a remote intelligence control and management system, and the detection data is sent to a business management system to generate measurement detection records and reporting certificates, while the remote intelligence control and management system can achieve the docking of multiple digital detection systems.

The above are only preferred embodiments of the present disclosure, and only used to help understand the method of the present disclosure and its core idea, the protection scope of the present disclosure is not limited to the above embodiments only, and the technical solutions under the idea of the present disclosure all belong to the protection scope of the present disclosure. It should be noted that for those of ordinary skill in the art, several improvements and modifications without departing from the principles of the present disclosure should also be regarded as the scope of protection of the present disclosure.

In the present disclosure, the problems that the efficiency is reduced, the cost is increased and the detection period is longer due to the fact that the digital noise measurement and analysis instrument has many measurement and detection items, and with the increase of the amount of the detected instrument, additional equipment and personnel are needed to carry out measurement and detection, and the problems that the development period is increased and the cost is increased due to insufficient laboratory qualification ability in the prior art are fundamentally solved. According to the remote intelligent control measurement and detection device and method for the noise measurement and analysis instrument provided by the present disclosure, by implementing the technical idea of “measurement and detection platform+Internet of Things remote intelligent control”, an intelligent IoT remote intelligent control system with an IoT video and data security as a core is constructed to achieve automatic control of the digital noise measurement and analysis instrument for measurement and detection, and at the same time achieve automatic analysis, calculation, processing, transmission and storage of detection data, and generation of the certificate report, and scientific big data related to the product quality can be formed.

What is claimed is:

1. A remote intelligent control measurement and detection device for a noise measurement and analysis instrument, comprising a remote intelligence control and certificate management system, a remote measurement and detection platform, an automatic detection device, a video monitoring system and a supporting facility, wherein the remote intelligence control and certificate management system is in two-way communication with the remote measurement and detection platform, the remote measurement and detection platform is in two-way communication with the automatic detection device, the video monitoring system and the supporting facility are in two-way communication with the remote intelligence control and certificate management system, and the automatic detection device comprises an anechoic chamber, a low-frequency coupler, a multi-function acoustic calibrator, a signal generator, a measurement amplifier, a high-fidelity test sound source, a power amplifier and a multi-channel signal analyzer;
a detection method of the detection device comprises the steps of:
S1, connecting the automatic detection device with a detected instrument by detection assisting personnel, and waiting for instructions from the remote intelligence control and certificate management system;
S2, issuing instructions to start testing by the remote intelligence control and certificate management system, and acquiring characteristic data of a to-be-detected instrument by the automatic detection device through a serial port or a network port, wherein the characteristic data comprises a model, a number, a sensitivity level, a frequency range, a measuring range, and a reference sound pressure level;
S3, remotely controlling the signal generator to send out signals of a specific frequency and amplitude according to the requirements of measurement and detection to detect the electrical performance and the acoustic performance of the detected instrument;
S4, acquiring measurement data of the to-be-detected instrument by a main control unit through a serial port or a network port;
S5, analyzing the measurement data, and calculating a test result to end a test of one measurement index, while automatically uploading the measurement data to a database of the remote intelligence control and certificate management system;
S6, repeating the steps S3 to S5 to complete detection of all measurement indexes; and
S7, prompting the detection to be completed and automatically generating original records and certificates of measurement and detection by the remote intelligence control and certificate management system;
the acoustic performance has two measurement and detection methods, and specific measurement and detection processes thereof respectively comprise the following steps:
S0, issuing instructions by the remote intelligence control and certificate management system, using the automatic detection device to achieve detection of conventional electrical performance measurement parameters, and detecting the acoustic performance, i.e., frequency weighting of acoustic signals, by a free field comparison method or a multi-function acoustic calibrator method using a standard microphone;
S1, the free field comparison method:
S1-1, detecting the acoustic performance by the free field comparison method using the standard microphone first needs to perform calibration on a sound pressure level of a free field in the anechoic chamber, and mainly comprises the following steps:
S1-1-1, performing measurement of sound field calibration by the remote measurement and detection platform, the low-frequency coupler, the anechoic chamber, the high-fidelity test sound source and the standard microphone;
S1-1-2, building a sound field automatic calibration system in the anechoic chamber to calibrate a position of the standard microphone;
S1-1-3, the sound field automatic calibration system comprising an electric telescopic rod and a laser positioning device, after the standard microphone is fixed to one end of the electric telescopic rod, performing three-way calibration on a position of the standard microphone and a position of a sound source by the laser positioning device, and finally guaranteeing that a center position of the standard microphone is coaxial with a center position of the sound source by adjusting the electric telescopic rod;
S1-1-4, constructing a sound field playback system in the anechoic chamber to calibrate the reference sound pressure level; and
S1-1-5, the sound field playback system in the anechoic chamber comprising the standard microphone, the high-fidelity test sound source, the signal generator and the remote measurement and detection platform, controlling, by the remote measurement and detection platform, the signal generator to send out an acoustic signal of a reference frequency through a high-fidelity sound source, reading a sound pressure level of the standard microphone through a serial port, adjusting a voltage value of the signal generator until a sound pressure level received by the standard microphone is the reference sound pressure level, and recording a current voltage value of the signal generator; and keeping the current voltage value unchanged, and playing signals by a digital detection system by means of an octave or fractional octave point frequency while recording a sound pressure level at each frequency point received by the standard microphone;
S1-2, after a sound pressure level of a free sound field is calibrated, replacing the standard microphone with the detected instrument, and ensuring that a position of a sound center of the detected instrument is the same as that of the standard microphone; and then reading the voltage value of the signal generator recorded in S1-1-5, and controlling the sound field playback system to send out an acoustic signal by the remote measurement and detection platform while reading and recording the sound pressure level at each frequency point of the detected instrument through a serial port; and
S1-3, automatically calculating a difference between the sound pressure level of the standard microphone and the sound pressure level of the detected instrument by the remote measurement and detection platform, and adding a correction value to finally obtain frequency weighting of an acoustic signal at each frequency point;
S2, the multi-function acoustic calibrator method; wherein the multi-function acoustic calibrator is used to simplify measurement of the acoustic performance, eliminate the use of the anechoic chamber, and reduce intervention of metering personnel on a measurement and detection process, improving the detection efficiency, and specific measurement steps comprise:
S2-1, measuring a microphone type correction value of the detected instrument by the multi-function acoustic calibrator;
S2-1-1, placing the detected instrument in the anechoic chamber, giving each frequency of the correction value according to instrument instructions, and measuring an output sound pressure level at each frequency point of the detected instrument by the remote measurement and detection platform;
S2-1-2, keeping a sound pressure level of each frequency in the anechoic chamber unchanged, replacing the detected instrument with a reference laboratory standard (i.e., LS2P) microphone, and keeping a position of a sound center of the detected instrument to be the same as that of the reference laboratory standard microphone; and reading a sound pressure level measured by the reference laboratory standard microphone by the remote measurement and detection platform on the same frequency point as that in S2-1-1;
S2-1-3, using the multi-function acoustic calibrator in the detected instrument in S2-1-1, controlling the multi-function acoustic calibrator to send out an acoustic signal of a corresponding frequency by the remote measurement and detection platform, and reading the output sound pressure level at each frequency point of the detected instrument;
S2-1-4, using the multi-function acoustic calibrator in the detected instrument in S2-1-2, controlling the multi-function acoustic calibrator to send out an acoustic signal of a corresponding frequency by the remote measurement and detection platform, and reading the output sound pressure level at each frequency point of the detected instrument;
S2-1-5, after the measurement is completed, calculating a correction value at each frequency point by the remote measurement and detection platform based on the following formula 1, and repeating S2-1-1 to S2-1-4 to calculate an average of the correction values by multiple measurements:
$${C}_{FF , SLM} = ( {L}_{ind 1} - {L}_{ind 3} ) - ( {L}_{ind 2} + {L}_{ind 4} ) - ( {L}_{p , F 1} - {L}_{p , F 2} ) + ( {L}_{p , P 1} - {L}_{p , P 2} ) + {C}_{F F , RM} ; \qquad Formula 1$$
the C_{FF,SLM} is a correction value of a free field which is effective for the used noise measurement and analysis instrument and the used multi-function acoustic calibrator;
the C_{FF,RM} is a correction value of a free field of a reference microphone;
the L_{ind1}, the L_{ind2}, the L_{ind3}, and the L_{ind4} are indicating levels during measurements 1, 2, 3, and 4, respectively;
the L_{p,F1} and the L_{p,F2} are sound pressure levels of a free field during measurements 1 and 2, respectively;
the L_{p,P1} and the L_{p,P2} are measured values of sound pressure levels applied with the multi-function acoustic calibrator during measurements 3 and 4, respectively;
S2-1-6, finally obtaining a correction value of the multi-function acoustic calibrator for the detected instrument, and saving the correction value in a sound field database; and
S2-2, using the multi-function acoustic calibrator to measure each frequency point of the detected instrument, and retrieving the correction value of the detected instrument in the database to finally obtain frequency weighting of the acoustic signal at each frequency point.

2. The remote intelligent control measurement and detection device for the noise measurement and analysis instrument according to claim 1, comprising a running status indicator light for accurately identifying a detection status.

3. The remote intelligent control measurement and detection device for the noise measurement and analysis instrument according to claim 1, wherein the video monitoring system comprises a video camera, a human face recognition device, and a fingerprint recognition system; and the supporting facility comprises a barometer, a thermometer and a hygrometer which enable remote communication.

4. The remote intelligent control measurement and detection device for the noise measurement and analysis instrument according to claim 1, wherein the remote intelligence control and certificate management system is connected with the remote measurement and detection platform through an Internet of Things remote transmission protocol, and the test instructions and the test results can be transmitted in real time through a data encryption technique, enabling remote environmental monitoring and access control data management, field test data collection and transmission, original record compilation, certificate report template matching and automatic certificate generation.

5. The remote intelligent control measurement and detection device for the noise measurement and analysis instrument according to claim 1, wherein deep mining of measurement data is carried out based on digital test data management, the deep mining of the measurement data comprising data mining of detection data, building a sound field database, and mining information of a standard measuring instrument, thus implementing an expiration reminder of a standard device, the information of the standard measuring instrument comprising a model, a number, a measurement range, an accuracy level, and a tracing period.

6. The remote intelligent control measurement and detection device for the noise measurement and analysis instrument according to claim 1, wherein the remote measurement and detection platform is connected with the automatic detection device and the detected instrument through a serial port or a network port, enabling control of the automatic detection device and acquisition of detection data.

7. The remote intelligent control measurement and detection device for the noise measurement and analysis instrument according to claim 1, wherein the remote intelligence control and certificate management system adopts a 4G/5G-VPN manner to establish a system special network; and data security protection is performed by RAS public key encryption during data transmission.

8. The remote intelligent control measurement and detection device for the noise measurement and analysis instrument according to claim 1, wherein a plurality of remote measurement and detection platforms adopt a manner of being separately deployed, avoiding the impact of platform abnormality on a testing business of other platforms, and increasing security; and a network interruption and continuous transmission mechanism is provided to ensure that data is not affected by emergency situations such as network port failure, server interruption, and main server downtime, improving reliability.
